(19) United States
(12) Patent Application Publication
(10) Pub. No.: US 2007/0181847 A1
(43) Pub. Date: Aug. 9, 2007

(54) FERRITE MATERIAL

(75) Inventors: Tomofumi Kuroda, Tokyo (JP); Isao Nakahata, Tokyo (JP); Masahiko Watanabe, Tokyo (JP); Masahito Furukawa, Tokyo (JP); Osamu Hasegawa, Tokyo (JP); Takuya Aoki, Tokyo (JP)

Correspondence Address: PEARNE & GORDON LLP, 1801 EAST 9TH STREET, SUITE 1200, CLEVELAND, OH, 44114-3108, US

(73) Assignee: TDK CORPORATION, Tokyo (JP)

(21) Appl. No.: 11/671,479

(22) Filed: Feb. 6, 2007

(30) Foreign Application Priority Data
Feb. 8, 2006 (JP) 2006-30378
Feb. 6, 2007 (JP) 2007-026971

(51) Int. Cl. H01F 1/00; C04B 35/26

(52) U.S. Cl. 252/62.62

(57) ABSTRACT

It is an object to provide a ferrite material which has a higher saturation magnetic flux density and low core loss, both at 100° C. The ferrite material is composed of a sintered body containing Fe, Mn and Zn as main constituents at x, y and z % by mol in terms of Fe₂O₃, MnO and ZnO, respectively, and containing Li as an additive at v % by weight in terms of Li₂CO₃ based on the main constituents, wherein x=55.7 to 60, z=3 to 8.5, y=100−x−z, v=0.3 to 0.8, and x1≦x≦x2 (x1=52.9−0.1z+8.5v and x2=54.4−0.1z+8.5v).

### BACKGROUND OF THE INVENTION

1. Field of the Invention

The present invention relates to a ferrite material having a high saturation magnetic flux density at high temperature around 100° C. and low core loss.

2. Description of the Related Art

Recently, electronic devices are increasingly becoming more compact and producing a higher output, which is accompanied by development of the various parts having a higher degree of integration and higher-speed processing capability. This, in turn, is requiring power supply lines to supply larger currents. Electronic parts such as transformers, choke coils or the like are also required to be serviceable at a high current and to work stably at around 100° C., because some devices in which they are used, e.g., vehicles, are serving in higher-temperature atmospheres or their temperature increases due to heat generation while they are working.

A ferrite core which constitutes a transformer, choke coil or the like is required to have a high saturation magnetic flux density at high temperature, e.g., around 100° C., to be serviceable at a high current. In order to meet these requirements, Japanese Patent Publication No. 63-59241, for example, proposes a ferrite core having a basic composition comprising manganese oxide at 13 to 50%, ZnO at 0 to 20% (excluding 0%), and at least one oxide selected from the group consisting of nickel oxide, magnesium oxide and lithium oxide at 0 to 26% (excluding 0%), the balance being iron sesquioxide, all percentages by mol, and serviceable at high temperature in a magnetic field of 500 mT or more.

Japanese Patent Laid-Open No. 2005-29417 discloses a sintered body containing Fe₂O₃ at 62 to 68%, ZnO at 12 to 20%, NiOat 5% or less (excluding 0%) and LiO_{0.5} at below 4% (excluding 0%), the balance substantiallybeingMnO as main constituents, all percentages by mol. Incorporation of both Ni and Li at given concentrations improves saturation magnetic flux density of the sintered body at high temperature. The sintered body has a saturation magnetic flux density of 480 mT or more at 100° C. and 1194 A/m, and minimum core loss of 1300 kW/m³ or less at 100 kHz and 200 mT.

Japanese Patent No. 3487243 discloses a ferrite material containing Fe₂O₃ at 54 to 56% and ZnO at 5 to 10%, the balance being MnO as main constituents, all percentages by mol, and Li₂CO₃ at 0.1 to 0.5%, CaCO₃ at 0.01 to 0.3% and SiO₂ at 0.001 to 0.05% as additives, all percentages by weight.

The ferrite disclosed by Japanese Patent Publication No. 63-59241 is characterized by minimum core loss temperature above 150° C. and gives no consideration to magnitude of core loss at working temperature.

The ferrite proposed by Japanese Patent Laid-Open No. 2005-29417 is incorporated with Ni and Li to have a high saturation magnetic flux density of 480 mT or more and relatively low loss of 1300 kW/m³or less as minimum core loss. However, a material of lower loss is required in consideration of efficiency of transformers and coils in which it is used. Moreover, it cannot be supplied to the markets at a low price, because NiO is relatively expensive.

The ferrite proposed by Japanese Patent No. 3487243 only attains a saturation magnetic flux density of 440 mT or less at 100° C., and cannot be used for transformers or choke coils working at a higher saturation magnetic flux density.

The present invention is developed to solve these technical problems. It is an object of the present invention to provide a ferrite material which has a higher saturation magnetic flux density and low core loss, both at 100° C.

### SUMMARY OF THE INVENTION

The ferrite material of the present invention is composed of a sintered body containing Fe, Mn and Zn as main constituents at x, y and z % by mol in terms of Fe₂O₃, MnO and ZnO, and containing Li as an additive at v % by weight in terms of Li₂CO₃ based on the main constituents, wherein x=55.7 to 60, z=3 to 8.5, y=100−x−z, v=0.3 to 0.8, and x1≦x≦x2 (x1=52.9−0.1z+8.5v and x2=54.4−0.1z+8.5v).

The ferrite material of the present invention preferably contains as additives Si at 50 to 300 ppm in terms of SiO₂ and Ca at 200 to 3000 ppm in terms of CaCO₃, both based on the main constituents. More preferably, it further contains one or both of Nb at 750 ppm or less (excluding 0 ppm) in terms of Nb₂O₅ and Ta at 1500 ppm or less (excluding 0 ppm) in terms of Ta₂O₅.

The ferrite material of the present invention can have a saturation magnetic flux density of 460 mT or more at 100° C. and 1194 A/m, core loss of 800 kW/m³ or less at 100° C., 100 kHz and 200 mT, and bottom temperature of 70° C. to 160° C., at which core loss attains a minimum.

The present invention provides a ferrite material of high saturation magnetic flux density at 100° C. and low core loss. It can have the following characteristics, saturation magnetic flux density of 460 mT or more at 100° C. and 1194 A/m, core loss of 800 kW/m³ or less at 100° C., 100 kHz and 200 mT, and bottom temperature of 70° C. to 160° C., at which core loss attains a minimum.

### DETAILED DESCRIPTION OF THE PREFERRED EMBODIMENTS

First of all, the reasons for limiting the range of each constituent are described.

The present invention contains Fe as one of the main constituents at 55.7 to 60% by mol (x) in terms of Fe₂O₃, (the Fe content (x) is hereinafter described simply as Fe₂O₃ content, and so on). At a Fe₂O₃ content below 55.7% by mol, the ferrite material may have an insufficient saturation magnetic flux density at 100° C. At a content above 60% by mol, on the other hand, it may have a notably increased core loss. Therefore, according to the present invention, it contains Fe₂O₃ at 55.7 to 60% by mol, preferably 56 to 59.5% by mol, more preferably 56 to 59% by mol.

ZnO content (z) also has influences on saturation magnetic flux density and core loss. At a ZnO content below 3% by mol, the ferrite material may have an increased core loss. At a content above 8.5% by mol, on the other hand, it may have an insufficient saturation magnetic flux density. Therefore, according to the present invention, it contains ZnO at 3 to 8.5% by mol, preferably 4 to 8% by mol, more preferably 5 to 7.5% by mol.

The ferrite material of the present invention contains MnO as another main constituent, which essentially constitutes the balance of the main constituents, except for unavoidably present impurities.

Next, the additives for the present invention are described.

The present invention contains Li₂CO₃ as an additive at 0.3 to 0.8% by weight. Li₂CO₃ is an effective constituent for improving saturation magnetic flux density at 100° C., and incorporated at 0.3% by weight or more based on the main constituents to realize its effect. However it may increase core loss at 100° C., when incorporated excessively. Therefore, according to the present invention, the ferrite material contains Li₂CO₃ at 0.8% or less by weight, preferably 0.3 to 0.75% by weight, more preferably 0.3 to 0.5% by weight.

The ferrite material of the present invention may contain SiO₂ and CaCO₃ as additives at 50 to 300 ppm and 200 to 3000 ppm, respectively. Si and Ca are segregated in the grain boundaries to form a high-resistance layer, thereby contributing to reduced loss. They also work as sintering aids to improve sintered body density. These effects may not be fully exhibited at a Si content below 50 ppm in terms of SiO₂ or at a Ca content below 200 ppm in terms of CaCO₃. On the other hand, discontinuous grain growth increases core loss at a Si content above 300 ppm in terms of SiO₂ or at a Ca content above 3000 ppm in terms of CaCO₃. It preferably contains SiO₂ at 50 to 150 ppm and CaCO₃ at 500 to 2000 ppm, more preferably SiO₂ at 75 to 125 ppm and CaCO₃ at 600 to 1200 ppm.

The present invention may further contain one or both of Nb₂O₅ at 750 ppm or less (excluding 0 ppm) and Ta₂O₅ at 1500 ppm or less (excluding 0 ppm) as additive(s) . Each of these additives has an effect of reducing core loss. Nb₂O₅ or Ta₂O₅ is preferably incorporated each at 20 ppm or more to fully exhibit its effect. Nb₂O₅ or Ta₂O₅ may no longer exhibit its effect of reducing core loss when incorporated at above 750 ppm or 1500 ppm, respectively. Nb₂O₅ is preferably incorporated at 30 to 400 ppm and Ta₂O₅ is preferably incorporated at 30 to 1000 ppm. It is therefore incorporated at a content in the above range. When Nb₂O₅ and Ta₂O₅ are simultaneously incorporated, the total content is preferably 1500 ppm or less.

The ferrite material of the present invention has a composition satisfying the relationship x1≦x≦x2 (x1=52.9−0.1z+8.5v and x2=54.4−0.1z+8.5v). In general, bottom temperature at which core loss attains a minimum is greatly determined by ferrite material constituents. The inventors of the present invention have found that a ferrite material has a practical bottom temperature, when it contains Fe₂O₃, ZnO and Li₂CO₃ in the above ratio. When Fe2O₃ content is below x1, the bottom temperature would be high at 180° C. or higher, giving an impractically large core loss at 100° C. At a content of Fe₂O₃ above x2, on the other hand, the bottom temperature would be impractically low of below 70° C., possibly causing thermo runaway when it is used as a transformer or a coil.

The ferrite material of the present invention having a composition adequately set in the above range can have a saturation magnetic flux density of 460 mT or more at 100° C. and 1194 A/m, preferably 465 mT or more, more preferably 470 mT or more.

It can also have a core loss of 800 kW/m³ or less at 100° C., 100 kHz and 200 mT, preferably 700 kW/m³ or less, more preferably 500 kW/m³ or less.

The ferrite material of the present invention can have a bottom temperature of 70 to 160° C., preferably 80 to 120° C., in addition to the above characteristics. Therefore, a ferrite part in which the ferrite material of the present invention is used should have a bottom temperature in a practical working temperature range.

Next, the suitable method for producing the ferrite material of the present invention is described.

For starting materials for the main constituents, powdered oxides or those compounds which can be converted into oxides when heat-treated are used. More specifically, powdered Fe₂O₃, Mn₃O₄, ZnO and so forth may be used. Their mean particle size may be adequately selected from a range of 0.1 to 3 μm.

Starting material powders for the main constituents are wet mixed, and then calcined at a given temperature in a range from 800 to 1000° C. for a stable time adequately set in a range from 0.5 to 5 hours. The calcined mixture is milled to a mean particle size of around 0.5 to 2 μm, for example. In the present invention, the starting material powders for the main constituents are not limited to the above. A compound oxide powder containing 2 or more metals may be used as a starting material powder for the main constituents. An aqueous solution containing iron chloride and manganese chloride, for example, can be roasted in an oxidative atmosphere to produce a compound oxide powder containing Fe and Mn. This powder may be mixed with ZnO powder to produce a starting material powder for the main constituents. In this case, calcination can be saved.

After calcination, additives are added. The calcined material may be incorporated with additives before milling, or starting materials of additives may be added and mixed after milling of the calcined material. Li₂CO₃ may be calcined together with the starting material powder for the main constituents.

For starting materials of the additives, powdered oxides or those compounds which can be converted into oxides when heat-treated can also be used. More specifically, powdered Li₂CO₃, SiO₂, CaCO₃, Nb₂O₅, Ta₂O₅ and so forth may be used.

The mixed powder composed of the main constituents and additives is granulated by, for example, a spray dryer to facilitate the subsequent compacting step. It is sprayed and dried in a spray dryer after being incorporated with a small quantity of adequate binder, e.g., polyvinyl alcohol (PVA). The resulting granules preferably have a particle size of around 80 to 300 μm.

The granules are compacted into a desired shape by, for example, a press having a mold of desired shape, and then sintered.

It is necessary to control sintering temperature and atmosphere in the sintering step.

The sintering temperature may be adequately set in a range from 1250 to 1450° C., preferably 1300 to 1400° C. for the ferrite material of the present invention to fully exhibit its effects.

The sintering atmosphere can be adequately adjusted to have a desired oxygen partial pressure in a nitrogen/oxygen atmosphere.

The sintered ferrite material of the present invention can have a relative density of 93% or more, preferably 95% or more.

### EXAMPLES

The present invention is described more specifically by Examples.

The starting materials contained powdered Fe₂O₃, MnO and ZnO as the main constituents, and powdered Li₂CO₃, SiO₂, CaCO₃, Nb₂O₅ and Ta₂O₅ as the additives. Table 1 gives the main constituent compositions and the additive compositions. These powders were wet mixed, and calcined at 900° C. for 3 hours in air.

The mixture obtained was incorporated with a binder, granulated, and formed into a compacted body of toroidal shape.

The compacted body obtained was sintered under controlled conditions of 1350° C. and oxygen partial pressure of 5% for 2 hours (the partial pressure and time were at the stable temperature level), to produce a ferrite core of toroidal shape. It had an outer diameter of 20 mm, inner diameter of 10 mm and thickness of 5 mm.

Each of the ferrite cores was analyzed for saturation magnetic flux density (Bs) at 100° C. and 1194 A/m, core loss (Pcv) at 100 kHz and 200 mT, and temperature at which the core loss attained a minimum (bottom temperature). The results are also given in Table 1, where x1 is defined as 52.9−0.1z+8.5v and x2 as 54.4−0.1z+8.5v.

TABLE 1

| | Main constituents (mol %) | | | | | Additives | | | | | | | Bottom |
|---|---|---|---|---|---|---|---|---|---|---|---|---|---|
| | Fe₂O₃ | MnO | ZnO | | | Li₂CO₃ | SiO₂ | CaCO₃ | Nb₂O₅ | Ta₂O₅ | Bs(100° C.) | Pcv(100° C.) | temperature |
| No. | (x) | (y) | (z) | X1 | X2 | (wt %) | (ppm) | (ppm) | (ppm) | (ppm) | (mT) | (kW/m³) | (° C.) |
| 1 | 56.30 | 34.20 | 9.50 | 54.95 | 56.45 | 0.35 | 110 | 800 | 50 | — | 454 | 491 | 110 |
| 2 | 53.00 | 39.00 | 8.00 | 52.10 | 53.60 | 0.00 | 110 | 800 | 50 | — | 433 | 391 | 110 |
| 3 | 55.19 | 36.81 | 8.00 | 54.15 | 55.65 | 0.24 | 110 | 800 | 50 | — | 455 | 409 | 100 |
| 4 | 56.19 | 35.81 | 8.00 | 55.10 | 56.60 | 0.35 | 110 | 800 | 50 | — | 460 | 437 | 100 |
| 5 | 57.21 | 34.79 | 8.00 | 56.17 | 57.67 | 0.48 | 110 | 800 | 50 | — | 463 | 508 | 90 |
| 6 | 57.76 | 34.24 | 8.00 | 57.37 | 58.87 | 0.62 | 110 | 800 | 50 | — | 466 | 589 | 110 |
| 7 | 53.35 | 40.15 | 6.50 | 52.25 | 53.75 | 0.00 | 110 | 800 | 50 | — | 450 | 314 | 110 |
| 8 | 54.94 | 38.56 | 6.50 | 54.30 | 55.80 | 0.24 | 110 | 800 | 50 | — | 459 | 395 | 100 |
| 9 | 56.04 | 37.46 | 6.50 | 55.25 | 56.75 | 0.35 | 110 | 800 | 50 | — | 462 | 407 | 110 |
| 10 | 56.03 | 37.31 | 6.50 | 56.32 | 57.82 | 0.48 | 110 | 800 | 50 | — | 447 | 928 | 180 |
| 11 | 56.44 | 36.90 | 6.50 | 56.32 | 57.82 | 0.48 | 110 | 800 | 50 | — | 460 | 611 | 150 |
| 12 | 56.64 | 36.69 | 6.50 | 56.32 | 57.82 | 0.48 | 110 | 800 | 50 | — | 462 | 615 | 140 |
| 13 | 56.85 | 36.49 | 6.50 | 56.32 | 57.82 | 0.48 | 110 | 800 | 50 | — | 460 | 605 | 130 |
| 14 | 57.46 | 36.04 | 6.50 | 56.32 | 57.82 | 0.48 | 110 | 800 | 50 | — | 468 | 473 | 100 |
| 15 | 57.87 | 35.46 | 6.50 | 56.32 | 57.82 | 0.48 | 110 | 800 | 50 | — | 465 | 817 | 60 |
| 16 | 58.69 | 34.81 | 6.50 | 57.52 | 59.02 | 0.62 | 110 | 800 | 50 | — | 475 | 554 | 100 |
| 17 | 53.50 | 41.50 | 5.00 | 52.40 | 53.90 | 0.00 | 110 | 800 | 50 | — | 452 | 418 | 110 |
| 18 | 55.14 | 39.86 | 5.00 | 54.45 | 55.95 | 0.24 | 110 | 800 | 50 | — | 453 | 417 | 100 |
| 19 | 56.24 | 38.76 | 5.00 | 55.38 | 56.88 | 0.35 | 110 | 800 | 50 | — | 463 | 554 | 110 |
| 20 | 57.87 | 37.13 | 5.00 | 56.47 | 57.97 | 0.48 | 110 | 800 | 50 | — | 472 | 629 | 90 |
| 21 | 58.90 | 36.10 | 5.00 | 57.67 | 59.17 | 0.62 | 110 | 800 | 50 | — | 473 | 740 | 100 |
| 22 | 59.41 | 35.59 | 5.00 | 59.00 | 60.50 | 0.78 | 110 | 800 | 50 | — | 472 | 780 | 100 |
| 23 | 61.50 | 33.50 | 5.00 | 60.46 | 61.96 | 0.95 | 110 | 800 | 50 | — | 475 | 850 | 100 |
| 24 | 53.75 | 43.25 | 3.00 | 52.60 | 54.10 | 0.00 | 110 | 800 | 50 | — | 450 | 466 | 120 |
| 25 | 55.55 | 41.45 | 3.00 | 54.65 | 56.15 | 0.24 | 110 | 800 | 50 | — | 454 | 509 | 110 |
| 26 | 56.55 | 40.45 | 3.00 | 55.60 | 57.10 | 0.35 | 110 | 800 | 50 | — | 462 | 627 | 110 |
| 27 | 57.56 | 39.44 | 3.00 | 56.67 | 58.17 | 0.48 | 110 | 800 | 50 | — | 463 | 740 | 90 |
| 28 | 58.80 | 38.20 | 3.00 | 57.87 | 59.37 | 0.62 | 110 | 800 | 50 | — | 464 | 798 | 100 |
| 29 | 57.75 | 39.75 | 2.50 | 56.73 | 58.23 | 0.48 | 110 | 800 | 50 | — | 462 | 885 | 100 |
| 30 | 56.04 | 37.46 | 6.50 | 55.23 | 56.73 | 0.35 | 45 | 800 | 150 | — | 470 | 506 | 100 |
| 31 | 56.04 | 37.46 | 6.50 | 55.23 | 56.73 | 0.35 | 70 | 800 | 150 | — | 469 | 450 | 100 |
| 32 | 56.04 | 37.46 | 6.50 | 55.23 | 56.73 | 0.35 | 110 | 800 | 150 | — | 465 | 405 | 100 |
| 33 | 56.04 | 37.46 | 6.50 | 55.23 | 56.73 | 0.35 | 175 | 800 | 150 | — | 469 | 441 | 100 |
| 34 | 56.04 | 37.46 | 6.50 | 55.23 | 56.73 | 0.35 | 250 | 800 | 150 | — | 471 | 431 | 100 |
| 35 | 56.04 | 37.46 | 6.50 | 55.23 | 56.73 | 0.35 | 110 | 300 | 150 | — | 467 | 549 | 90 |
| 36 | 56.04 | 37.46 | 6.50 | 55.23 | 56.73 | 0.35 | 110 | 800 | 150 | — | 465 | 405 | 100 |
| 37 | 56.04 | 37.46 | 6.50 | 55.23 | 56.73 | 0.35 | 110 | 1900 | 150 | — | 463 | 404 | 100 |
| 38 | 56.04 | 37.46 | 6.50 | 55.23 | 56.73 | 0.35 | 110 | 2800 | 150 | — | 461 | 720 | 100 |
| 39 | 56.04 | 37.46 | 6.50 | 55.23 | 56.73 | 0.35 | 110 | 800 | — | — | 465 | 475 | 100 |
| 32 | 56.04 | 37.46 | 6.50 | 55.23 | 56.73 | 0.35 | 110 | 800 | 150 | — | 465 | 405 | 100 |
| 40 | 56.04 | 37.46 | 6.50 | 55.23 | 56.73 | 0.35 | 110 | 800 | 500 | — | 463 | 407 | 100 |
| 41 | 56.04 | 37.46 | 6.50 | 55.23 | 56.73 | 0.35 | 110 | 800 | 1000 | — | 464 | 626 | 100 |
| 42 | 56.04 | 37.46 | 6.50 | 55.23 | 56.73 | 0.35 | 110 | 800 | — | 1000 | 462 | 426 | 100 |
| 43 | 56.04 | 37.46 | 6.50 | 55.23 | 56.73 | 0.35 | 110 | 800 | — | 2000 | 466 | 720 | 100 |
| 44 | 56.04 | 37.46 | 6.50 | 55.23 | 56.73 | 0.35 | 110 | 800 | 350 | 50 | 469 | 390 | 100 |
| 45 | 56.04 | 37.46 | 6.50 | 55.23 | 56.73 | 0.35 | 110 | 800 | 250 | 500 | 465 | 414 | 100 |

The results give the following findings.

The ferrite material can have only a low saturation magnetic flux density Bs below 460 mT at 100° C. (hereinafter, “at 100° C.” is skipped), when its Fe₂O₃ content (x) is below 55.7% by mol (Sample Nos. 2, 3, 7, 8, 17, 18, 24 and 25). At a content (x) above 60% by mol (Sample No. 23), on the other hand, core loss Pcv at 100° C. (hereinafter, “at 100° C.” is skipped) exceeds 800 kW/m³.

It should be noted, however, that the ferrite material can have only a low saturation magnetic flux density Bs below 460 mT and, at the same time, a core loss Pcv exceeding 900 kW/m³ because bottom temperature increases to as high as 180° C. at below x1 (52.9−0.1z+8.5v) even when its Fe₂O₃ content (x) is in a range from 55.7 to 60% by mol (Sample No. 10), and that it has a core loss Pcv exceeding 800 kW/m³ because bottom temperature decreases to 60° C. at above x2 (54.4−0.1z+8.5v) even when its Fe₂O₃ content (x) is in a range from 55.7 to 60% by mol (Sample No. 15).

At a ZnO content (z) below 3% by mol, the ferrite material has a core loss Pcv exceeding 800 kW/m³ (Sample No. 29). At a ZnO content (z) above 8.5% by mol, on the other hand, it can have only a low saturation magnetic flux density Bs below 460 mT (Sample No. 1).

Moreover, the ferrite material can have only a low saturation magnetic flux density Bs below 460 mT, when it contains Li₂CO₃ as an additive at below 0.3% by weight (Sample Nos. 2, 3, 7, 8, 17, 18, 24 and 25). At a Li₂CO₃ content above 0.8% by weight, on the other hand, core loss Pcv exceeds 800 kW/m³ (Sample No. 23).

By contrast, the ferrite material can have characteristics of 460 mT or more at 100° C. as saturation magnetic flux density Bs, 800 kW/m³ or less at 100° C. as core loss Pcv and 70° C. or higher as bottom temperature, when it contains Fe₂O₃ at 55.7 to 60% by mol (x), with the relationship x1≦x≦x2 being satisfied (x1=52.9−0.1z+8.5v and x2=54.4−0.1z+8.5v) and ZnO content (z) at 3 to 8.5% by mol, the balance being MnO as the main constituents, and Li₂CO₃ as an additive at 0.3 to 0.8% by weight based on the main constituents.

Next, the other additives are described.

SiO₂ and CaCO₃ are segregated in the grain boundaries to form a high-resistance layer, thereby contributing to reduced loss, and also work as sintering aids to improve sintered body density, as discussed earlier at the same time. They affect core loss Pcv, as shown in Table 1. In other words, incorporation of SiO₂ and CaCO₃ can reduce core loss Pcv. As shown in Table 1, however, SiO₂ and CaCO₃ have their own peak effect (See Sample Nos. 30 to 34 and 35 to 38). Therefore, SiO₂ and CaCO₃ contents are set at 50 to 300 ppm and 200 to 3000 ppm, when they are incorporated.

Moreover, incorporation of Nb₂O₅ and Ta₂O₅ also can reduce core loss Pcv (See Sample Nos. 32 and 39 to 45 in Table 1). They also have their own peak effect, as is the case with SiO₂ or CaCO₃. Their optimum amounts to be added are set at 750 ppm or less with Nb₂O₅ and 1500 ppm or less with Ta₂O₅.

1. A ferrite material composed of a sintered body
containing Fe, Mn and Zn as main constituents at x, y and z% by mol in terms of Fe₂O₃, MnO and ZnO, respectively, and
containing Li as an additive at v % by weight in terms of Li₂CO₃ based on the main constituents, wherein
x=55.7 to 60,
z=3 to 8.5,
y=100−x−z,
v=0.3 to 0.8, and
x1≦x≦x2 (x1=52.9−0.1z+8.5v and x2=54.4−0.1z+8.5v).

2. The ferrite material according to claim 1, containing as additives
Si at 50 to 300 ppm in terms of SiO₂ and
Ca at 200 to 3000 ppm in terms of CaCO₃, both based on the main constituents.

3. The ferrite material according to claim 2, containing as an additive
Nb at 750 ppm or less (excluding 0 ppm) in terms of Nb₂O₅ based on the main constituents.

4. The ferrite material according to claim 2, containing as an additive
Ta at 1500 ppm or less (excluding 0 ppm) in terms of Ta₂O₅ based on the main constituents.

5. The ferrite material according to claim 2, containing as additives
Nb at 750 ppm or less (excluding 0 ppm) in terms of Nb₂O₅ and
Ta at 1500 ppm or less (excluding 0 ppm) in terms of Ta₂O₅, both based on the main constituents.

6. The ferrite material according to claim 1, having
a saturation magnetic flux density of 460 mT or more at 100° C. and 1194 A/m,
a core loss of 800 kW/m³ or less at 100° C., 100 kHz and 200 mT, and
a bottom temperature of 70 to 160° C., at which core loss attains a minimum.

7. The ferrite material according to claim 1, wherein
x=56 to 59.5.

8. The ferrite material according to claim 1, wherein
x=56 to 59.

9. The ferrite material according to claim 1, wherein
z=4 to 8.

10. The ferrite material according to claim 1, wherein
z=5 to 7.5.

11. The ferrite material according to claim 1, wherein
v=0.3 to 0.75.

12. The ferrite material according to claim 1, wherein
v=0.3 to 0.5.

13. The ferrite material according to claim 1, wherein
x=56 to 59.5,
z=4 to 8, and
v=0.3 to 0.75.

14. The ferrite material according to claim 1, wherein
x=56 to 59,
z=5 to 7.5, and
v=0.3 to 0.5.

15. The ferrite material according to claim 1, containing as additives
Si at 50 to 150 ppm in terms of SiO₂ and
Ca at 500 to 2000 ppm in terms of CaCO₃, both based on the main constituents.

16. The ferrite material according to claim 2, containing as an additive
Nb at 20 to 750 ppm in terms of Nb₂O₅ based on the main constituents.

17. The ferrite material according to claim 2, containing as an additive
Ta at 20 to 1500 ppm in terms of Ta₂O₅ based on the main constituents.

18. The ferrite material according to claim 2, having
a saturation magnetic flux density of 460 mT or more at 100° C. and 1194 A/m,
a core loss of 800 kW/m³ or less at 100° C., 100 kHz and 200 mT, and
a bottom temperature of 70 to 160° C., at which core loss attains a minimum.

19. The ferrite material according to claim 3, having
a saturation magnetic flux density of 460 mT or more at 100° C. and 1194 A/m,
a core loss of 800 kW/m³ or less at 100° C., 100 kHz and 200 mT, and
a bottom temperature of 70 to 160° C., at which core loss attains a minimum.
